(19) United States
(12) Patent Application Publication
(10) Pub. No.: US 2014/0260853 A1
(43) Pub. Date: Sep. 18, 2014

(54) INDUSTRIAL SLICER

(71) Applicant: Giorgio GRASSELLI, Albinea (IT)

(72) Inventor: Giorgio GRASSELLI, Albinea (IT)

(21) Appl. No.: 14/204,866

(22) Filed: Mar. 11, 2014

(30) Foreign Application Priority Data
Mar. 13, 2013 (IT) MI2013A000380

(51) Int. Cl. B26D 5/20; B26D 3/18; B26D 7/06; B26D 1/56

(52) U.S. Cl. CPC B26D 5/20; B26D 1/56; B26D 3/18; B26D 7/0625
USPC 83/76.1; 83/418; 83/284; 83/310

(57) ABSTRACT

The invention discloses an industrial slicer (1) of food products, comprising a frame (2), at least one cutting member (5) mounted on the frame (2) and movable with respect thereto with a cutting movement lying in a cutting plane (P2), and means for guiding and conveying (6) the food product in a direction (3) through the cutting plane (P2), wherein the slicer is characterised in that the at least one cutting member (5) exhibits a cutting movement of a rotational and translational type lying in the cutting plane (P2).

The object of the present invention is an industrial slicer.

Specifically, the object of the present invention is an industrial slicer that finds advantageous application in the food industry for cutting products such as meat, poultry, fish, and vegetables, that are preferably fresh or cooked and without bones or cartilage.

This industrial slicer is used to cut the food product into slices, strips or cubes of various dimensions based on the intended end use.

By way of example, the industrial slicer is used to process deep-frozen products and precooked products for large-scale distribution networks or small-scale distribution channels, fresh or precooked products for the individual user, portions for school or business cafeterias and fresh or precooked products intended for the restaurant and food service sector in general.

In the state of the art, it is known that the above-mentioned industrial slicers have an hourly output of cut food products that only theoretically reaches two metric tons/hour.

Considering the production capacity that can be achieved, it is evident that these industrial slicers are employed more effectively if they are inserted within a well-organised, preferably automated, production line. This aspect does not, however, prevent individual, that is, “stand-alone” utilisation, perhaps with a number of machines in parallel, which may also be managed manually by a specialised operator for each industrial slicer.

In further detail, the use of the industrial slicer for cutting a food product that is prismatic in shape (with varying proportions in the three main dimensions), essentially comprises three different cutting techniques, each being more suited to a particular type of food product.

In a first case, the technique comprises cutting by combining a first set of blades arranged in the same plane and keyed onto the same rotating shaft, with a second set of disc-shaped blades fitted onto a shaft, each one rotating in a transverse (perpendicular) plane with respect to the first set of rotating blades.

In a second case, the technique comprises combined cutting with a first set of blades set in motion with reciprocating rectilinear movement, also arranged perpendicularly to each other and all lying in a plane in a grid-like fashion, facing a second final rotating blade that rotates in a plane parallel to the plane of the set of fixed blades.

In a third case, the cutting technique comprises combined simultaneous cutting with a fixed flat blade, a set of disc-shaped blades arranged similarly to the first case, but with a perpendicular cut with respect to the fixed blade, and lastly a rotating shaft provided with a set of peripheral blades for the final cut, passing from the food product to strips, to prism- or cube-shaped pieces, as the case may be.

All these techniques refer to a structure of a standard type of industrial slicer of the prior art, in which auxiliary members for conveying the incoming and outcoming product are also normally included.

An example of an industrial slicer of the standard type is described and illustrated in document EP 0931630 A2.

Specifically, the conveying members are constituted by conveyor belts arranged in closed loops on rollers, usually a pair, of which one is generally a driving roller and the other is the driven roller.

In further detail, the typical feed unit comprises a pair of said belts arranged in such a manner that the plane defined by each belt is horizontal and being such as to face each other. The lower belt usually has both rollers with the axes solidly constrained to the base of the slicer, whereas the upper belt is structured in such a manner that the position of the axis of rotation of one of the two rollers (generally the driven roller) moves circularly about the axis of the other roller (generally the driving roller).

This configuration makes it possible to obtain a pivot about which the plane defined by the upper belt can be oriented, rotating it with respect to an axis, in this case, the rotation axis of the driving roller.

In the use of the industrial slicer, the orientation of said plane is typically adjusted so as to enable the proper contrast (pressure) on the food product that advances on the lower conveyor belt during the cutting process. With this aim, the contrast is reached by means of suitable compound levers connected to a contrast unit. This contrast unit is generally of a pneumatic type and manually adjusted by the operator based on the types of food products to be processed and thus on the amount of contrast needed for cutting.

It is evident that the position of the plane defined by the upper conveyor belt is a result of the anatomy, the consistency and the amount of product that has been loaded in the feed unit of the slicer and about to be cut.

Industrial slicers that are based on these cutting techniques are subject to several limits, in terms of flexibility regarding use and in terms of the quality of the final processed food product.

In fact, the cut product, above all as regards meats, has areas in which the fibre is torn and not cut cleanly by the blade(s). This leads to a limitation in the use of the processed product in subsequent processes and handling in the food industry, in addition to a reduction affecting the aesthetic qualities and the presentation of the same product in the “semi-finished” state as offered to the individual user.

Moreover, as regards the mechanical structure of the slicers of the prior art, there are marked constraints in terms of the adaptability thereof, in accordance with the food product to be processed. This forces the generic processing department of a food industry to be supplied with a number of machines configured and equipped in accordance with the specific food product that is to be processed each time.

Furthermore, precisely owing to the main cutting techniques described hereinabove, these industrial slicers constitute a limitation on automated production lines: the amount of food product processed per hour is often incompatible with the speed of the entire production line. The classic slowing-down of the chain of production owing to the so-called “bottleneck effect” created by the slicer is a consequence of this.

This problem prevalently leads to two negative aspects: the first is that placement of a specialised operator becomes necessary for management of the passage of the product into the slicer during the cutting stage; at the same time, the risk of contamination of the same product increases markedly owing to this further handling of the product.

This contamination is even more probable in the case of production lines that process food products that are already precooked or cooked, perhaps even already cooled to ambient temperature.

Therefore, in conformity with strict health and quality control standards for the food sector, the above-mentioned high risk of contamination, along with the aesthetic appearance flawed by possible tearing during the cutting stage, often leads to the formation of large amounts of scrap from the processed product.

All these considerations contribute to making industrial slicers an indispensable part of production lines that process mainly meats, but they have a series of unresolved limitations as regards efficient and effective placement on the production line.

From the standpoint of the food industry, two scenarios can thus emerge. In the first scenario, in the case of a newly-created project for and start-up of a new production line, the slicer(s) to be placed along the line must be planned adequately in advance so that all the other equipment and auxiliary systems will be compatible with the performance and needs for use of these industrial slicers.

In the second case, the placement of one or more slicers on a pre-existing production line involves considerable efforts, including financial efforts, to adapt the line to the model(s) of industrial slicer(s) chosen, as it is a machine that is hardly alterable or flexible in terms of use.

In this context, the technical task of the present invention is to make available an industrial slicer that is free of the drawbacks cited hereinabove.

Specifically, an aim of the present invention is to make available an industrial slicer that has a high level of functional flexibility together with a level of quality of the cut food product that is clearly higher than that which has been obtained as yet with the prior art.

Furthermore, an aim of the present invention is to propose a new industrial slicer capable of reducing production times and costs for the processing of cooked, precooked or fresh food products.

These and other aims are substantially achieved by an industrial slicer according to that which is described in one or more of the attached claims. The dependent claims correspond to additional embodiments of the industrial slicer according to the present invention.

Further characteristics and advantages will emerge more clearly from the detailed description of a preferred, but not exclusive, embodiment of an industrial slicer according to the invention.

This description is provided with reference to the accompanying drawings, which are also intended purely by way of non-limiting example, and in which:

FIG. 1 is a schematic view of the cross-section of an industrial slicer according to the present invention;

FIG. 2 is a detailed schematic perspective view of an industrial slicer according to the present invention;

FIG. 3 is another schematic perspective view with the detail of an element of an industrial slicer according to the present invention;

FIG. 4 is a schematic representation of the cutting sequence of an industrial slicer according to the present invention;

FIG. 5 is a partial schematic view of an industrial slicer according to the present invention.

FIG. 6 is a block diagram of the control unit of the slicer of the present invention.

With reference to the attached figures, an industrial slicer according to the present invention has been indicated in its entirety by the number “1”.

Herein below, for the sake of simplicity, cooked, precooked or fresh foods such as meats, fish (provided that they are free of bones or cartilaginous parts) and vegetables shall be referred to generically as the food product. In the preferred embodiment, which is illustrated in FIGS. 1 and 4, the industrial slicer 1 comprises a frame 2 for supporting all the structural elements and movable elements.

The reference number 3 defines a conveying direction of the food product, which, in accordance with the attached drawing of FIG. 1, is disposed from the right side towards to left side of the figure oriented normally.

With reference to the conveying direction 3 of the food product, the product itself encounters at least one cutting element 4 that moves along a plane “P1” and a cutting member 5 that moves along a plane “P2” that is such as to be perpendicular to the cutting plane “P1”. The term cutting zone is intended as the zone at the cutting element 4 and/or cutting member 5.

The reference number 6 indicates elements for guiding and conveying the food product through the above-mentioned planes.

With the present configuration, the guiding and conveying elements 6 are constituted by conveyor belts, hereinafter referred to as lower and upper loading conveyor belts 7 and 8, respectively, being such as to define the above-mentioned conveying direction 3.

Furthermore, the resting surface for the lower loading conveyor belt 7 defines a resting plane 9, which is preferably disposed horizontally.

Advantageously, the cutting plane “P1” of the cutting element 4 is disposed parallel to the conveying direction 3 of the food product, whereas the cutting plane “P2” of the cutting member 5 is disposed perpendicularly to the conveying direction 3 of the food product.

In further detail, as illustrated in FIG. 4, said cutting planes “P1” and “P2” are preferably disposed perpendicularly to each other, where the cutting planes “P1” and “P2” are disposed along the above-mentioned guiding and conveying elements 6 of the industrial slicer 1.

The cutting element 4 preferably comprises at least one blade, preferably a plurality of blades 10 disposed in a vertical direction, all being parallel to the cutting plane “P1” and with the cutting edge facing against the conveying direction 3.

Preferably, said plurality of blades 10 is fixed to supporting cross-pieces 10a that run from one end of the industrial slicer 1 to the other, and are such as to surmount the designated zone for cutting, leaving it free of any interference or obstruction.

Preferably, the plurality of blades 10 indicated hereinabove extends along the direction of the supporting cross-pieces 10a for a distance therebetween equal to an amount referred to as the “pitch”.

By way of example, in the embodiment illustrated in the attached figures, the pitch of the blades 10 is constant from one end to the other of the plurality of blades of the cutting element 4.

In another embodiment of the present invention, which is not illustrated in the attached figures, the pitch of the plurality of blades 10 is preferably differentiated by sectors.

In other words, the blades 10 are subdivided into sets, each having a different pitch, selected according to pre-established criteria for processing the food product. The combinations of sets of blades 10 having different pitches are practically endless.

The blades 10 indicated hereinabove are preferably actuated so as to achieve a vertical movement in the respective plane “P1” and particularly, an opposite movement between adjacent blades, that is to say, while one blade moves vertically upwards, the two adjacent blades on either side of the first blade move vertically downwards. In a pre-established time interval (usually a few fractions of a second), this procedure is repeated in the reverse direction, and thus repeated in alternation thereafter.

This movement, which is realized for example by mechanisms 10b based on a crank and connecting rod system of motion or with other solutions, makes it possible to keep the food product stable and compact at all times in the process of cutting with the cutting element 4.

The present industrial slicer is equipped with one or more fixed elements called blade guides 11 in the cutting zone; said blade guides 11 are disposed transversely with respect to the conveying direction 3 and structured so as to have open slits for the blades 10 to pass through, without creating friction or interference therewith.

Advantageously, as illustrated in the figures attached to the present invention, the blade guide 11 makes it possible to prevent the blades from bending at the moment in which the food product is offering resistance to them and to provide a rest surface for the food product when cutting is in progress.

In a different embodiment of the present invention, which is not illustrated in the attached figures, the blade guide 11 is not mounted on board the industrial slicer.

In this configuration, the food product is cut by bringing the guiding and conveying elements 6 closer to the cutting zone.

Preferably, the loading conveyor belts 7 and 8 are arranged in closed loops on respective rollers 12.

Advantageously, there is defined, as illustrated in FIG. 5, an entrance section 13 for the food product and it is such as to be delimited in width by the breadth of the lower loading conveyor belt 7 or by the total breadth of the plurality of blades 10 (consider the smallest of the two measurements, indicating it with “L”), and in height based on the distance of the loading conveyor belts 7 and 8 in proximity to idler rollers 12 that face the blades 10 in a direction perpendicular to the resting surface 9.

This distance is the direct result of the contrast that the upper loading belt conveyor 8 creates on the portion of food product resting on the lower loading conveyor belt 7 and advancing along the conveying direction 3.

This entrance section 13 is the opening through which the portion of food product subjected to cutting is guided and forced. In fact, the upper loading conveying belt 8 also has the function of pressing on the food product at least during passage through the entrance section 13.

By combining the two movements, that is, the reciprocating vertical movement of the plurality of blades 10 along the cutting plane “P1”, with the passage of the food product through the entrance section 13 according to the conveying direction 3, vertical slices 20 of the food product are realised, as illustrated for example in FIG. 4.

More specifically, the thickness of the slices (that is, transversely) generally depends on the pitch of the plurality of blades 10, whereas the width (therefore, vertically) thereof is usually a function of the anatomy, the amount and the consistency of the inserted food product.

According to the present invention, which is illustrated in the attached FIG. 4, the food product is subjected to cutting by the cutting member 5 following the cutting process carried out by the cutting element 4.

In fact, further passage of the food product through the cutting plane “P2” permits a transverse cut, advantageously disposed perpendicularly to the cut made from the previous passage through the cutting plane “P1”.

Advantageously, said cutting member 5 comprises a blade 14 that is structured in such a manner as to have the cutting edge disposed in a horizontal direction, preferably parallel to the resting plane 9 and lying in the cutting plane “P2”.

The vertical slices 20 of the food product are thus cut up into portions 21 that are preferably prismatic in shape, as illustrated in FIG. 4, and then collected on a conveying element 6, preferably an unloading conveyor belt 15, with the aim of moving the portions 21 away from the cutting zone. Advantageously, the blade 14 of the cutting member 5 is constrained to a supporting cross-piece 16 disposed in such a manner as to extend from one end of the industrial slicer to the other, so that it surmounts the designated zone for cutting, leaving it free of any interference or obstruction.

Advantageously, as illustrated also by FIG. 3 attached hereto, the ends of the supporting cross-piece 16 are structured in such a manner that the cross-piece is constrained to eccentric elements 17.

Advantageously, the simultaneous actuation of the eccentric elements 17, the supporting cross-piece 16 and the blade 14, which are interconnected, is realised by one or more electric motors 18, which are preferably of a “brushless” type.

Preferably, one “brushless” electric motor installed for each end of the supporting cross-piece 16 and they rotate according to axes “X”.

The industrial slicer constituting the object of the present invention advantageously offers synchronised actuation of the “brushless” electric motors, thus such as to confer to the blade 14 connected thereto by means of the supporting cross-piece 16 and eccentric elements 17, a movement of a rotational and translational type that is identical on each end of the supporting cross-piece 16.

As illustrated in the attached figures, the axis of rotation “X” of the “brushless” electric motors 18 is preferably perpendicular to the plane on which the blade 12 moves, namely the cutting plane “P2”.

The rotational and translational type of movement of the blade 14 advantageously results in a clean cut, without ruining the edges during the cutting process.

Advantageously, the food product being cut with the blade 14 and undergoing planar movement of a rotational and translational type, has portions 21 of product preferably prismatic in shape with even and well-defined surfaces, without tears and/or rips, resulting from a precise and accurate cut.

Advantageously, the dimensions of the above-mentioned prismatic portions are obtained by the combination of the speed of advancement of the loading conveyor belts 7 and 8 along the conveying direction 3, with the rotational speed of the “brushless” electric motors 18 along the axes “X”, that is, the rapidity of the rotational and translational movement of the blade 14.

Preferably, the speed of advancement of the two loading conveyor belts 7 and 8 along the conveying direction 3 is synchronised.

Advantageously, the synchronised combination of the speed of advancement of the loading conveyor belts 7 and 8 along the conveying direction 3, with the rotational speed of the “brushless” electric motors 18 along the axes “X”, makes it possible to obtain endless forms of cutting solutions for the prismatic portions of food product.

The described synchronisation functions are achieved by means of a control unit 19 controlling the slicer.

In other words, the industrial slicer has an electronic type of control to control the electric motors responsible for moving the cutting member 5, the loading conveyor belts 7 and 8 and the unloading conveying belts 15.

In other words, the slicer comprises a control unit 19, which is illustrated by means of a block diagram in FIG. 6, and it is configured to control the cutting member 5, the loading conveyor belts 7, 8, the unloading conveyor belts 15 and the electric motors responsible for moving the cutting elements.

In general, it should be noted that in the present context and in the claims that follow, the control unit 19 is presented as subdivided into distinct function modules (memory modules or operating modules) for the sole purpose of describing the functions thereof clearly and completely.

Actually, this control unit 19 can consist of a single electronic device, suitably programmed to perform the functions described, and the various modules can correspond to hardware entities and/or routine software that are part of the programmed device.

Alternatively or additionally, these functions can be carried out by a plurality of electronic devices, in which the above-mentioned function modules can be distributed.

The control unit 19 can also use one or more processors for execution of the instructions contained in the memory modules.

Furthermore, the above-mentioned function modules can be distributed in various local or remote computers based on the structural design of the network in which they are located.

The control unit 19 comprises a first operating module 191.

The first operating module 191 is configured to regulate the speed of the cutting member 5.

In other words, the first operating module 191 is configured to set a speed v1 for the cutting member 5 based on desired dimensions d1 of the food product.

Preferably, the first operating module 191 is configured to set the speed v1 of the cutting member 5 based on desired dimensions d1 of the food product entered by means of a user interface 199.

Specifically, the first operating module 191 is configured to set the speed v1 of the cutting member 5 so that the blade 14 will cut the food product preferably parallel to the resting plane 9 in the cutting plane “P2”.

In the preferred embodiment, the first operating module 191 is configured to command the brushless motor(s) 18 in such a manner that the food product shall be cut to the desired dimensions d1.

Preferably, the first operating module 191 is configured to manage the brushless motors 18 independently.

The guaranteed technical effect consists in improved management of the motors in the event of mechanical failure of one of the two motors.

Advantageously, according to the invention, the operating module 191 comprises a pair of sub-modules configured to detect the actual functioning of the two motors 18, at predetermined intervals of time.

The first operating module 191 is further configured to receive signals representative of the functioning of the two motors from the sub-modules and to manage the distribution of work between the two motors based on the functioning thus detected.

Specifically, the first operating module 191 is configured to put a motor in neutral if it proves not to be functioning from the representative signals received from the sub-modules.

The technical effect achieved is to avoid the “dragging” of the motor that is not working by the motor that is working.

The control unit 19 comprises a second operating module 193 configured to regulate the speed of the lower loading conveyor belt 7.

In other words, the second operating module 193 is configured to set a speed v3 for the lower loading conveyor belt 7.

Specifically, the third operating module 193 is configured to set the speed v3 for the lower loading conveyor belt 7 based on the desired dimensions d1 and the speed of a loading line, located upstream that feeds it.

Advantageously, according to the invention, synchronisation of the lower loading conveyor belt 7 with the line upstream allows continuous cycle operation of the slicer within a complete cycle including the feeding and slicing of food products.

The control unit 19 comprises a third operating module 194 configured to regulate the speed of the upper loading conveyor belt 8.

In other words, the third operating module 194 is configured to set a speed v4 for the upper loading conveyor belt 8 based on the speed v3 of the lower loading conveyor belt 7. Specifically, these speeds are the same.

The third operating module 194 is also configured to maintain pressure on the upper loading conveyor belt 8 so that it is transmitted to the portion of food product resting on lower loading conveyor belt 7 and advancing along the conveying direction 3.

In this manner, the food product resting on the lower loading conveyor belt 7 is accompanied and pushed against the cutting element 4.

The control unit 19 comprises a fourth operating module 195 configured to regulate the speed of the unloading conveyor belt 15.

In other words, the fourth operating module 195 is configured to set a speed v5 for the unloading conveyor belt 15 based on the previously set cutting speeds.

Advantageously, according to the invention, the control unit 19, comprises a calculation module 196 configured to calculate values of at least one among the cutting speeds v1, v3, v4, v5, based on the dimensions d1 requested by means of the user interface 199.

In other words, the calculation module 196 is configured to synchronise the operation of the loading conveyor belts 7, 8, the unloading conveyor belt 15 and the cutting member 5.

In general, the calculation module 196 is configured to synchronise the operation of at least two among the loading conveyor belts 7, 8, the unloading conveyor belt 15 and the cutting member 5.

The electronic control 19 can be managed by a skilled operator using the user interface 199.

In one embodiment, this control is managed directly on board the machine; in other words, the user interface 199 is local to the slicer; specifically, it is mounted on the frame of the slicer.

In a different embodiment, this control is advantageously manageable remotely as well, outside the context of the production department, from other terminals or computers by means of the transmission of data through cables or over airwaves; in other words, the user interface 199 is disposed remotely with respect to the slicer.

According to the invention, the electronic type of management of the electric motors connected to the cutting or conveying members of the slicer makes it possible to achieve a plurality of configurations of the industrial slicer described, one of which makes it possible to use the feed speed according to the conveying direction 3 separately, that is, in a manner that is not synchronised with the speeds of the cutting elements 4 and 5.

In a further configuration of the slicer, the cutting speed of the cutting element 4 (that is, the plurality of vertical blades 10) and the rotational and translational speed of the cutting member 5 are separate, that is, they are not synchronised.

In one configuration of the industrial slicer, the highest speed of the loading conveyor belts 7 and 8 along the conveying direction 3, with respect to the set rotational speed of the “brushless” electric motors 18 along the axes “X”, makes it possible to obtain prism-shaped portions of product that are elongated, according to the direction 3.

In a different configuration of the industrial slicer, the increase in the rotational speed of the “brushless” electric motors 18 along the axes “X” makes it possible to obtain prism-shaped portions of product that are less elongated, more uniform, and even cube-shaped, with respect to the first configuration illustrated above.

In the embodiment of the invention 1 illustrated in the attached figures, the blade 14 provided with rotational and translational movement is realised as a single piece, preferably of a metal type, and it is structured so as to enable easy removal for routine maintenance or replacement when needed.

In a different embodiment, which is not illustrated, the blade 14 is constituted by a plurality of blades coupled to each other and constrained to the supporting cross-piece 16.

Moreover, in a different embodiment, which is not illustrated, the blade 14 is constituted by a threadlike element, preferably a strand made of resistant material compatible with the hygienic requirements of the food industry and with the stresses occurring in the process of cutting the food product.

In an unillustrated variation of the present configuration, the invention has only one electric motor of the “brushless” type 18 for moving the cutting member 5. Specifically, the motor of the “brushless” type 18 is constrained to a point on the frame 2 of the industrial slicer 1 and it actuates the eccentric elements 17 by means of a mechanical power transmission element of a flexible type, for example a toothed belt, a transmission chain or a similar element.

The electric motor of the “brushless” type 18 can be fixed to a movable base, provided, that is, with at least rotatory movement at least partially on one end so as to enable regulation of the mechanical power transmission element, for example the tension of the toothed belt or the transmission chain.

In one specific case of this configuration, either the cutting element or the cutting member can be excluded from the process of cutting the food product, according to current needs.

For example, in a first operative state, the cutting element 4 can be excluded so as to obtain slices cut by the cutting member 5 preferably perpendicularly to the conveying direction 3.

More specifically, in said first configuration, preferably, the cutting element 4 is removed from the industrial slicer. In other words, the cutting element 4 comprising the plurality of blades 10 is not included on board the slicer.

In a second operative state, the cutting member 5 can be excluded and the cutting element 4 can be left to operate, so as to obtain vertical slices 20 without interruption, according to the portion of food product inserted. The structural design of the frame 2 of the industrial slicer 1 provides for the option of releasing the cutting elements 4 and 5 from the process, without having to make substantial changes to the frame 2, for routine maintenance or replacement as needed.

According to the illustrated embodiment, the at least one cutting element 4 is disposed upstream of the cutting member 5 according to the conveying direction 3 of the food product. According to a possible embodiment, which is not illustrated, the at least one cutting element 4 is disposed downstream of the cutting member 5 according to the conveying direction 3 of the food product.

The present invention achieves the set aims, overcoming the drawbacks of the prior art described hereinabove.

The object of the present invention permits use compatible with an existing production line, and permits cutting without interruption, on already cooked, precooked or fresh food products.

The possibility of continuous cutting of a food product leads to an advantageous reduction or the elimination of downtime for changing cutting sizes, and thus for changing the configurations of the machine based on the product to be processed.

Moreover, owing to these advantages, the adjustments needed for insertion of the invention on a pre-existing production line are resolved, reducing the time and costs for setting it up for operation.

Likewise, during the stage of planning and designing a new production line, accessory elements can be inserted, such as guide elements and conveying elements whose performances, technical specifications for assembly and costs are already known.

Advantageously, the object of the present invention offers a method and control for guiding and conveying the food product, so that the product advancement and cutting speed is synchronised, or in any case, compatible, with that of the conveyor belts of the production line.

In addition, the internal structure supporting the industrial slicer of the present invention is such as to completely disconnect the cutting zone from the area occupied by the guide and conveying elements, thus releasing the position of the food product from these elements.

The industrial slicer which constitutes the object of the present invention thus enables free management of the cutting line, without limitations in terms of the dimensions of the line and without having to interrupt passage of the product in order to deal with the portion still remaining to be cut.

This aspect leads to a further advantage, that is to say, the reduction of the possibility of the food product being contaminated especially if it is already cooked or pre-cooked.

In fact, in the process of cutting with the slicer constituting the object of the present invention, the product that is placed on the conveyor belt remains in the same position even during and after the cutting process through the slicer.

In addition, it is by virtue of the intrinsic characteristics of the industrial slicer described that the advantageous option of inserting the slicer along the line, immediately after the oven and before the blast chiller, is offered, thus further reducing the possibility of contamination of the product.

A more precise, thinner and cleaner cut, together with a minimum possibility of contamination—both of which are ensured by the present invention—allow for an advantageous reduction of the amount of scrap formed during normal processing of the food product.

The industrial slicer constituting the object of the present invention, enables electronic management on board the machine, which can be programmed by means of algorithms that are enabled by default or established by the operator, and in fact permits a myriad of configurations for use, which may also differ considerably one from the other. In this manner, the flexibility and efficiency of the present invention are superior to that which is presently available in the prior art.

Preferably, the industrial slicer comprises means for separately controlling 19 the cutting movements of the cutting member 5 in terms of the time employed and space travelled.

Preferably, the industrial slicer comprises means for excluding 19 the cutting member 5 from the slicer as an alternative.

Preferably, the industrial slicer comprises at least one blade guide element 11 that is suitable for cooperating with the cutting element 4 and positioned adjacent to the additional cutting plane P1.

Preferably, the industrial slicer comprises means for guiding and conveying 6 the food product in a direction 3 through said cutting plane P2 and said means is structured in such a manner as to compress the food product.

1. An industrial slicer (1) of food products, comprising:
a frame (2);
at least one cutting member (5) mounted on the frame (2) and movable with respect thereto with a cutting movement lying in a cutting plane (P2);
devices for guiding and conveying (6) the food product in a direction (3) through the cutting plane (P2);
wherein the at least one cutting member (5) exhibits a cutting movement of a rotational and translational type lying in the cutting plane (P2);
characterised in that it comprises at least one rotating eccentric element (17) suitable for realising the cutting movement of a rotational and translational type.

2. The industrial slicer (1) according to claim 1, characterised in that the cutting plane (P2) is such as to be disposed perpendicularly to the conveying direction (3) of the food product.

3. The industrial slicer (1) according to claim 1, comprising at least one cutting element (4) mounted on the frame (2) and suited to realising a cut lying in an additional cutting plane (P1) disposed perpendicularly to the cutting plane (P2), the guiding and conveying devices (6) being suited to conveying the food product in a direction (3) through the cutting plane (P2) and the additional cutting plane (P1).

4. The industrial slicer (1) according to claim 3, wherein the at least one cutting element (4) is mounted on the frame (2) and movable with respect thereto such as to obtain a movement suitable for realising a cut lying in an additional cutting plane (P1) disposed perpendicularly to the cutting plane (P2).

5. The industrial slicer (1) according to claim 3, characterised in that the additional cutting plane (P1) is such as to be disposed parallel to the conveying direction (3) of the food product.

6. The industrial slicer (1) according to claim 4, characterised in that the additional cutting plane (P1) is such as to be disposed parallel to the conveying direction (3) of the food product.

7. The industrial slicer (1) according to claim 3, wherein the cutting member (5), the cutting element (4) and the devices for guiding and conveying (6) the food product in a direction (3) are structured in such a manner as to correlate the cutting movements with the conveying of the food product in a direction (3).

8. The industrial slicer (1) according to claim 4, wherein the cutting member (5), the cutting element (4) and the devices for guiding and conveying (6) the food product in a direction (3) are structured in such a manner as to correlate the cutting movements with the conveying of the food product in a direction (3).

9. The industrial slicer (1) according to claim 5, wherein the cutting member (5), the cutting element (4) and the devices for guiding and conveying (6) the food product in a direction (3) are structured in such a manner as to correlate the cutting movements with the conveying of the food product in a direction (3).

10. The industrial slicer (1) according to claim 3, wherein the cutting member (5) and the cutting element (4) exhibit cutting movements of a rotational and translational type with directions lying in the cutting plane (P2) and the additional cutting plane (P1), respectively.

11. The industrial slicer (1) according to claim 3, wherein the cutting member (5) and the cutting element (4) exhibit cutting movements of a rotational and translational type with directions lying in the cutting plane (P2) and the additional cutting plane (P1), respectively.

12. The industrial slicer (1) according to claim 3, wherein the cutting member (5) and the cutting element (4) exhibit cutting movements of a rotational and translational type with directions lying in the cutting plane (P2) and the additional cutting plane (P1), respectively.

13. The industrial slicer (1) according to claim 3, wherein the cutting member (5) and the cutting element (4) exhibit cutting movements of a rotational and translational type with directions lying in the cutting plane (P2) and the additional cutting plane (P1), respectively.

14. The industrial slicer (1) according claim 1, wherein the cutting member (5) and/or the cutting element (4) exhibit the cutting movements of a reciprocating rectilinear type with directions lying in the cutting plane (P2) and the additional cutting plane (P1), respectively.

15. The industrial slicer (1) according claim 1, wherein the cutting member (5) and/or the cutting element (4) exhibit the cutting movements of a reciprocating rectilinear type with directions lying in the cutting plane (P2) and the additional cutting plane (P1), respectively.

16. The industrial slicer (1) according claim 1, wherein the cutting member (5) and/or the cutting element (4) exhibit the cutting movements of a reciprocating rectilinear type with directions lying in the cutting plane (P2) and the additional cutting plane (P1), respectively.

17. The industrial slicer (1) according to claim 1, wherein the cutting member (5) comprises at least one blade (14) mounted on a supporting cross-piece (16) lying in the cutting plane (P2) and constrained at the ends thereof by the at least one rotating eccentric element (17).

18. The industrial slicer (1) according claim 17, wherein the at least one rotating eccentric element (17) is set in motion by at least one electric motor of the “brushless” type (18).

19. The industrial slicer (1) according to claim 1, wherein the devices for guiding and conveying (6) the food product in a direction (3) through the cutting plane (P2) and the additional cutting plane (P1), is set in motion by at least one electric motor of the “brushless” type (18).

20. The industrial slicer (1) according to claim 7, wherein the devices for guiding and conveying (6) the food product in a direction (3) through the cutting plane (P2) and the additional cutting plane (P1), is set in motion by at least one electric motor of the “brushless” type (18).

21. The industrial slicer (1) according to claim 1, comprising a control unit (19) configured to control one or more among the cutting member (5), the loading conveyor belts (7), (8), and the unloading conveyor belts (15).

22. The industrial slicer (1) according to the preceding claim, wherein the control unit (19) comprises a first operating module (191) configured to set a speed (v1) for the cutting member (5) based on desired dimensions (d1) of the food product.

23. The industrial slicer (1) according to claim 22, wherein the control unit (19) comprises a calculation module (196) configured to calculate values of at least one cutting speed (v1, v3, v4, v5) based on the required dimensions (d1) of the food product.

24. The industrial slicer (1) according to claim 23, wherein the control unit (19) comprises a calculation module (196) configured to calculate values of at least one cutting speed (v1, v3, v4, v5) based on the required dimensions (d1) of the food product.

25. The industrial slicer (1) according to claim 24, wherein the calculation module (196) is configured to synchronise the operation of at least two among the lower loading conveyor belt (7), the upper loading conveyor belt (8), the unloading conveyor belt (15) and the cutting member (5).
